(19) United States
(12) Patent Application Publication
(10) Pub. No.: US 2022/0297255 A1
(43) Pub. Date: Sep. 22, 2022

(54) AIR GUIDER

(71) Applicant: X'POLE PRECISION TOOLS INC., Taoyuan (TW)

(72) Inventors: Ding-Yao CHENG, Taoyuan (TW); Chih-Chung LIN, Taoyuan (TW); Yu-Fan WEN, Taoyuan (TW); Wen-Hsien SU, Taoyuan (TW)

(21) Appl. No.: 17/724,827

(22) Filed: Apr. 20, 2022

Related U.S. Application Data
(63) Continuation-in-part of application No. 17/205,851, filed on Mar. 18, 2021.

(51) Int. Cl. B24B 23/02; B24B 55/02

(52) U.S. Cl. CPC B24B 23/028; B24B 55/02

(57) ABSTRACT

An air guider disposed in a grinding machine tool. The grinding machine tool comprises a casing and a motor disposed in the casing. The casing comprises a head for disposing the motor and a body formed with at least one air inlet. The air guider comprises a main body, and an ascending diversion portion integrally formed with the main body, the main body is disposed at a junction between the head and the body, the ascending diversion portion comprises a main guide surface to guide a first heat dissipation airflow entering from the air inlet to flow toward a top of the motor, and two auxiliary guide surfaces respectively disposed on two sides of the main guide surface to generate a second heat dissipation airflow.

### CROSS-REFERENCE TO RELATED APPLICATION

This application is a continuation-in-part application of U.S. patent application Ser. No. 17/205,851 filed on Mar. 18, 2021, entitled “GRINDING MACHINE TOOL FOR REDUCING HOTNESS OF CASING”.

### FIELD OF THE INVENTION

The invention relates to an air guider installed in a grinding machine tool, and more particularly to an air guider guides a first heat dissipation airflow entering from a casing to flow toward a top of a motor.

### BACKGROUND OF THE INVENTION

It is found that the motor of a grinding machine tool is prone to generate thermal energy after being used for a long time. Although the existing grinding machine tools are equipped with a fan on a side of the motor, and the fan rotates with an output shaft and outputs a wind current toward the motor; however, the wind current can only flow toward the side of the motor facing the fan, resulting in the heat on the side of the conventional motor that does not face the fan cannot be dissipated, which causes uneven heat dissipation of the motor and the thermal energy on the motor will continue to accumulate and transfer to the motor casing.

Further, the existing motors are mostly arranged at a position at which the user holds the grinding machine tool. In order to reduce dust flowing into the machine tool, the conventional grinding machine tools employ a machine tool casing to seal off the inside of the machine body, resulting in the gas inside the machine tool being incapable of flowing. After the motor has been used for a long time, a large amount of thermal energy is prone to accumulate on the side of the motor that does not face the fan, and is transferred to the casing of the grinding machine tool through thermal radiation, which causes the casing of the grinding machine tool to heat up and thus is unfavorable for the user to hold.

In order to solve the aforementioned problem that it is not easy to dissipate heat inside the grinding machine tool, U.S. Pat. No. 7,270,598 discloses a conventional grinding machine tool technology that introduces external air into the inside of a grinding machine tool to dissipate heat. Specifically, the conventional grinding machine tool uses a dust suction tube to suck the dust-containing gas generated during grinding in order to change the gas pressure inside the machine tool, so that external air can enter into the machine tool and then enter into the dust suction tube through an air inlet. The external air passes through the motor while flowing toward the dust suction tube and dissipates heat from the motor. However, since the conventional heat dissipation mechanism is such that the flow direction of the external air after flowing into the machine tool is different from the flow direction of the dust-containing airflow, the external air and the dust-containing airflow easily interfere with each other and cause turbulence. Furthermore, when the conventional dust suction tube extracts dust, the dust suction airflow has to enter into the dust suction tube through the space inside the machine tool, resulting in the grinding machine tool being incapable of blocking the dust in the dust suction airflow from flowing into the grinding machine tool, and therefore the dust is prone to accumulate on the conventional motor and other electronic components to affect the operation of the components.

In addition, in order to solve the aforementioned problems, patents such as CN 110270930A and U.S. Pat. No. 9,408,513B no longer use the conventional heat dissipation mechanism for heat dissipation, that is, the grinding machine tools disclosed in patents CN 110270930A and U.S. Pat. No. 9,408,513B are not equipped with an air inlet through which external air enters, instead employ the casings of the grinding machine tools to seal off the inside of the machine tools in order to reduce dust accumulation. Further, the motors and the grinding machine tool casings in patents CN 110270930A and U.S. Pat. No. 9,408,513B are arranged spacedly apart from each other, thereby reducing the thermal energy accumulated by the motors from being transferred to the grinding machine tool casings. However, the grinding machine tools of CN 110270930A and U.S. Pat. No. 9,408,513B can still only dissipate heat locally on the motors, the motors still have the problem of uneven heat dissipation, and the heat dissipation solution of the motors not touching the casings of the grinding machine tools can only reduce the speed at which heat on the motors is transferred to the casings, but cannot specifically solve the problems of thermal energy accumulation on the motors and transfer of heat from the motors to the casings. Furthermore, since the conventional fan cannot introduce external air into the machine tool, the fan can only drive the gas inside the machine tool to form a wind current. After the conventional grinding machine tool has been used for a long time, heat accumulated on the motor and circuit board inside the grinding machine tool will cause the temperature of the gas inside the machine tool to rise, and the wind current generated by the fan will also heat up and cannot provide effective heat dissipation for the motor, resulting in the machine tool casing will still receive thermal energy from the motor and become hot. In addition, since the conventional grinding machine tool has a closed structure, and external air cannot flow into the machine tool to cool down the air inside the machine tool, the casing of the grinding machine tool may be affected by the internal air and heat up, which is unfavorable for the user to hold.

### SUMMARY OF THE INVENTION

A main object of the invention is to solve the problem that the conventional grinding machine tool with a closed casing being incapable of specifically reducing hotness of the machine tool casing. In order to achieve the above object, the invention provides an air guider disposed in a grinding machine tool. The grinding machine tool comprises a casing and a motor disposed in the casing. The casing comprises a head for disposing the motor and a body formed with at least one air inlet. The air guider comprises a main body, and an ascending diversion portion integrally formed with the main body, the main body is disposed at a junction between the head and the body. The ascending diversion portion is located on a side of the main body facing the body, and the ascending diversion portion comprises a main guide surface which guides a first heat dissipation airflow entering from the air inlet to flow toward a top of the motor, and two auxiliary guide surfaces which are respectively disposed on two sides of the main guide surface to generate a second heat dissipation airflow.

In one embodiment, the air guider comprises two descending diversion portions respectively connected to two sides of the ascending diversion portion, and the two descending diversion portions are integrally formed with the main body.

In one embodiment, at least one of the two descending diversion portions tapers from a part thereof connected to the ascending diversion portion toward a direction opposite from the ascending diversion portion.

In one embodiment, at least one of the two descending diversion portions gradually expands from a part thereof connected to the ascending diversion portion toward a direction opposite from the ascending diversion portion.

In one embodiment, the ascending diversion portion extends from a bottom edge of the main body to reach a top edge of the main body, and a width of the ascending diversion portion at the bottom edge of the main body is smaller than a width of the ascending diversion portion at the top edge of the main body.

In one embodiment, the auxiliary guide surface is composed of a plurality of curved surfaces.

In one embodiment, the main body is in an arc shape.

In one embodiment, two sides of the main body are respectively an inclined surface.

In one embodiment, the air guider comprises two flow blockers respectively disposed on two sides of the ascending diversion portion, and the two flow blockers are integrally formed with the main body.

In one embodiment, the main body is in an arc shape, and the two flow blockers are respectively located on two sides of the main body.

In one embodiment, the air guider comprises a wire opening disposed on the main body.

According to the foregoing disclosure, compared with the conventional technology, the invention has the following features: the air guider of the invention is disposed at the junction between the head and the body of the casing, the ascending diversion portion on the air guider faces the body of the casing, the ascending diversion portion comprises the main guide surface for guiding the first heat dissipation airflow entering from the air inlet and flowing toward the top of the motor, and the two auxiliary guide surfaces respectively disposed on the two sides of the main guide surface for generating the second heat dissipation airflow; thereby the air guider is capable of specifically preventing a position of the casing on which a user holds from becoming hot.

### BRIEF DESCRIPTION OF THE DRAWINGS

FIG. 1 is a perspective view of a first embodiment of the invention.

FIG. 2 is an exploded perspective view of partial structures of the first embodiment of the invention.

FIG. 3 is exploded schematic diagrams of cross-sectional structures of the first embodiment of the invention.

FIG. 4 is a top view of partial components of the first embodiment of the invention.

FIG. 5 is a first schematic diagram of airflow of the first embodiment of the invention.

FIG. 6 is a second schematic diagram of airflow of the first embodiment of the invention.

FIG. 7 is a perspective view of a second embodiment of the invention.

FIG. 8 is an exploded perspective view of the second embodiment of the invention.

FIG. 9 is cross-sectional exploded diagrams of a structure of the second embodiment of the invention.

FIG. 10 is a schematic diagram of airflow of the second embodiment of the invention.

FIG. 11 is a schematic diagram of airflow of a third embodiment of the invention.

FIG. 12 is a schematic diagram of airflow of a fourth embodiment of the invention.

### DETAILED DESCRIPTION OF THE PREFERRED EMBODIMENTS

The detailed description and technical contents of the present invention are described below with reference to the drawings.

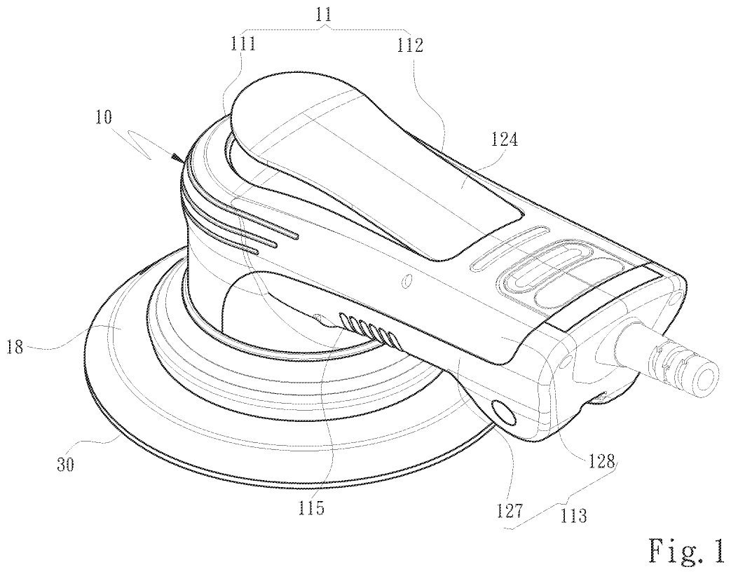

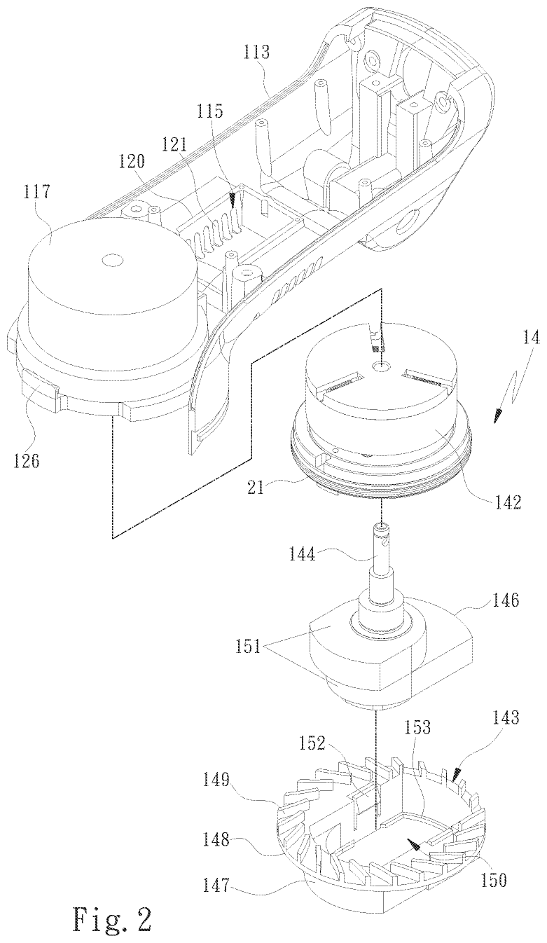

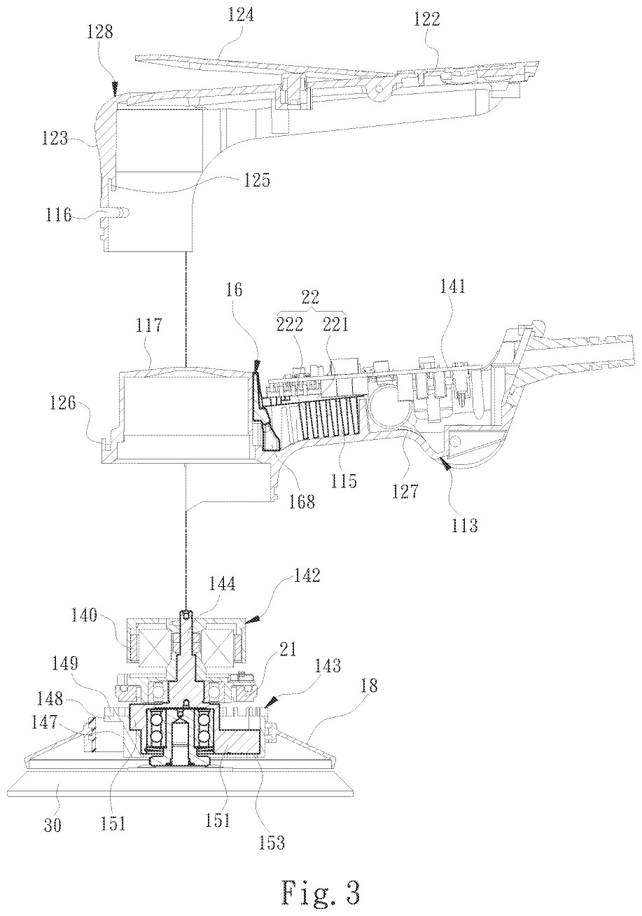

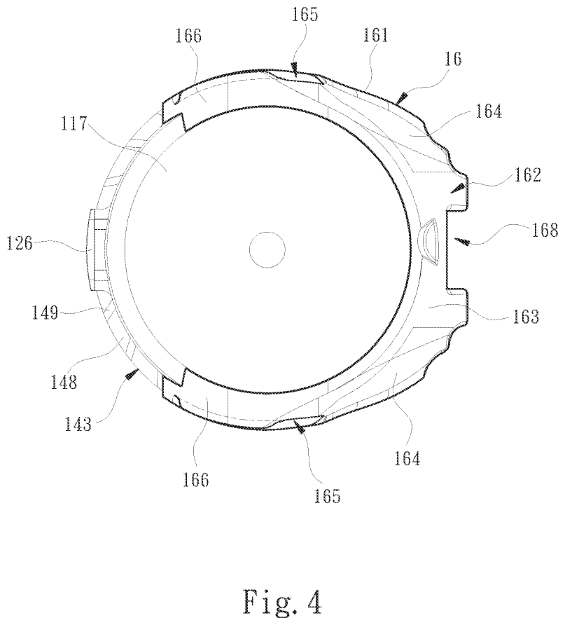

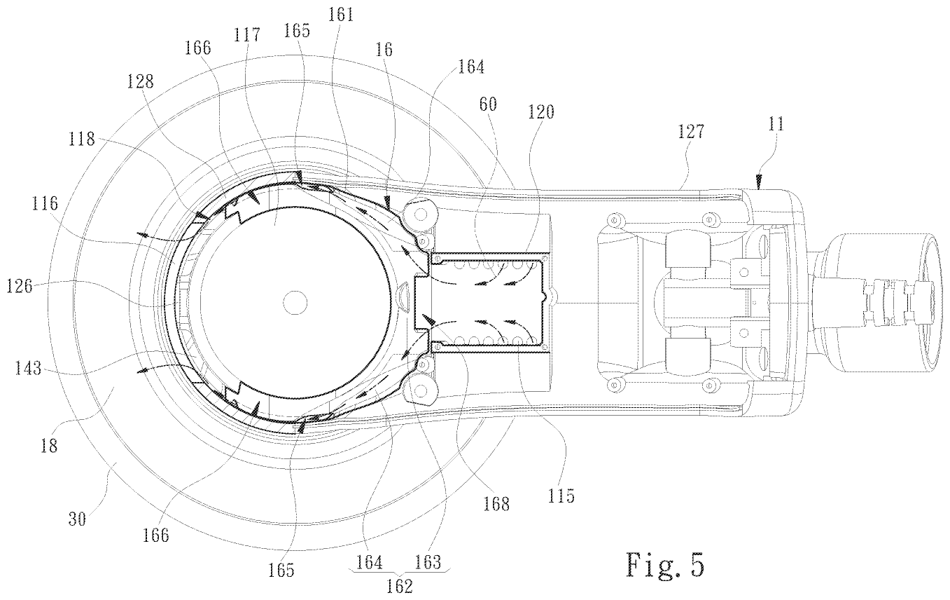

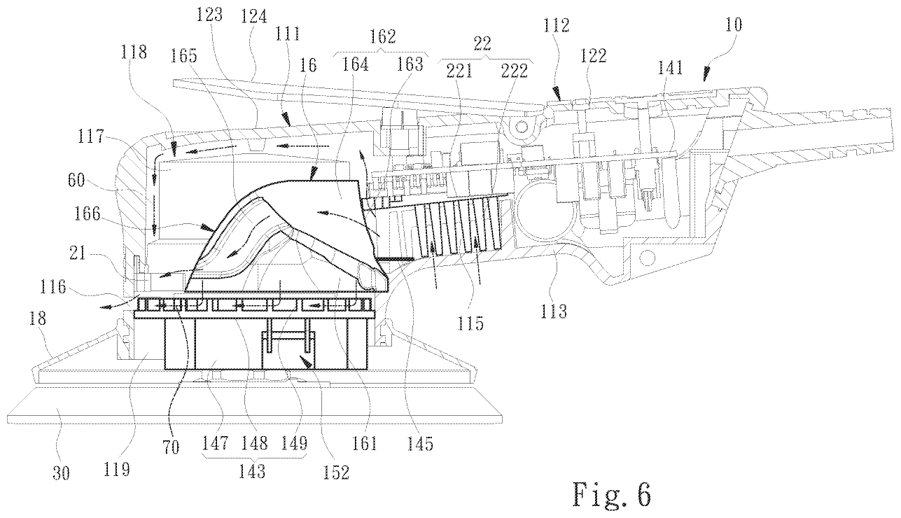

Please refer to FIG. 1, FIG. 2, FIG. 3, FIG. 4, FIG. 5 and FIG. 6. The invention provides a grinding machine tool 10 for reducing hotness of a casing. The grinding machine tool 10 is used in conjunction with a grinding member 30, and the grinding machine tool 10 includes a casing 11 and a drive assembly 14. The casing 11 is divided into a head 111 and a body 112. Specifically, the head 111 of the casing 11 is at a position at which a user's palm holds on when operating the grinding machine tool 10, and the body 112 of the casing 11 is at a position at which the user's wrist or arm abuts against when operating the grinding machine tool 10. The casing 11 is composed of at least two casing parts 113 which are composed of a shape of the grinding machine tool 10, the casing 11 includes an air inlet 115 formed on the body 112 and an air outlet 116 formed on a side of the head 111 opposite to the body 112, and the air inlet 115 and the air outlet 116 are respectively located at positions that will not be shielded by the user when the user operates the grinding machine tool 10. In addition, the casing 11 is provided with a motor cover 117 on the head 111, and the motor cover 117 is open at a side facing the grinding member 30. In more detail, after completion of assembling the at least two casing parts 113, the motor cover 117 does not contact the at least two casing parts 113 to have a gap inbetween, so that an airflow passage 118 communicating with the air inlet 115 and the air outlet 116 is formed between the casing 11 and the motor cover 117.

The drive assembly 14 includes a circuit board 141 provided in the casing 11, a motor 142 electrically connected to the circuit board 141, and an airflow generating member 143 rotating synchronously with the motor 142. Specifically, the motor 142 is placed from an open side of the motor cover 117 and is partially shielded by the motor cover 117. The airflow generating member 143 is located on a side of the motor 142 facing the grinding member 30. After the airflow generating member 143 is assembled, the open side of the motor cover 117 is shielded, so that an end of the motor 142 that is not shielded by the motor cover 117 faces the airflow generating member 143. In addition, the motor 142 is activated after receiving electric power from the circuit board 141, and an output shaft 144 of the motor 142 is rotated to drive the grinding member 30 to perform grinding operations. Furthermore, when the motor 142 operates, the airflow generating member 143 is rotated synchronously, and a first heat dissipation airflow 60 and a second heat dissipation airflow 70 are generated when the airflow generating member 143 rotates.

Specifically, gas pressure changes in the head 111 when the airflow generating member 143 rotates, so that external air enters from the air inlet 115 and transforms into the first heat dissipation airflow 60, and the first heat dissipation airflow 60 enters the casing 11 and flows along the airflow passage 118. Since the motor 142 is shielded by the motor cover 117, the first heat dissipation airflow 60 cannot flow into the motor 142 but flows along the motor cover 117 and an inner wall surface of the head 111, and then the first heat dissipation airflow 60 is guided by the airflow generating member 143 to be discharged from the air outlet 116. The first heat dissipation airflow 60 exchanges heat with the circuit board 141 during a flowing process, and then exchanges heat with the motor cover 117 when flowing through the head 111, so as to take away the thermal energy accumulated on the circuit board 141, and reduce heat of the motor 142 to be transferred to the motor cover 117. On the other hand, when the airflow generating member 143 rotates, a side of the motor 142 facing the airflow generating member 143 changes gas pressure to generate the second heat dissipation airflow 70. The second heat dissipation airflow 70 exchanges heat with the side of the motor 142 facing the airflow generating member 143, and the second heat dissipation airflow 70 is guided by the airflow generating member 143 to be discharged from the air outlet 116 to the outside during the flowing process. Thereby the second heat dissipation airflow 70 is capable of dissipating heat of the side of the motor 142 facing the airflow generating member 143, and the heat of the side of the motor 142 facing the airflow generating member 143 can be discharged outside of the casing 11.

In addition to dissipating heat from the side of the motor 142 facing the airflow generating member 143 by the second heat dissipation airflow 70 in the invention, after the casing 11 is assembled, the invention further utilizes the airflow passage 118 formed by the motor cover 117 without contacting the at least two casing parts 113, so that the first heat dissipation airflow 60 is capable of flowing in the airflow passage 118 to change airflow in the casing 11, thereby reducing a circumstance that thermal energy on a conventional circuit board and a conventional motor transfers thermal radiation to a conventional casing due to poor air circulation inside the conventional grinding machine tool, and also solving the problem of uneven heat dissipation of the conventional grinding machine tool. Furthermore, when the first heat dissipation airflow 60 flows through the airflow passage 118, since the motor 142 is shielded by the motor cover 117, the first heat dissipation airflow 60 cannot flow into the motor 142 but flows along a surface of the motor cover 117 and the inner wall surface of the head 111, thereby the first heat dissipation airflow 60 is capable of exchanging heat with the motor cover 117 and the head 111, and reducing dust in the first heat dissipation airflow 60 to be flew into the motor 142. In addition, when the first heat dissipation airflow 60 of the invention flows through the casing 11, the first heat dissipation airflow 60 not only dissipates heat of the motor 142, but the first heat dissipation airflow 60 can further simultaneously exchange heat with the circuit board 141. The first heat dissipation airflow 60 takes away heat accumulated on the circuit board 141 during the flowing process, reduces heat of the circuit board 141 being transferred to the casing 11, thereby preventing the casing 11 from getting hot.

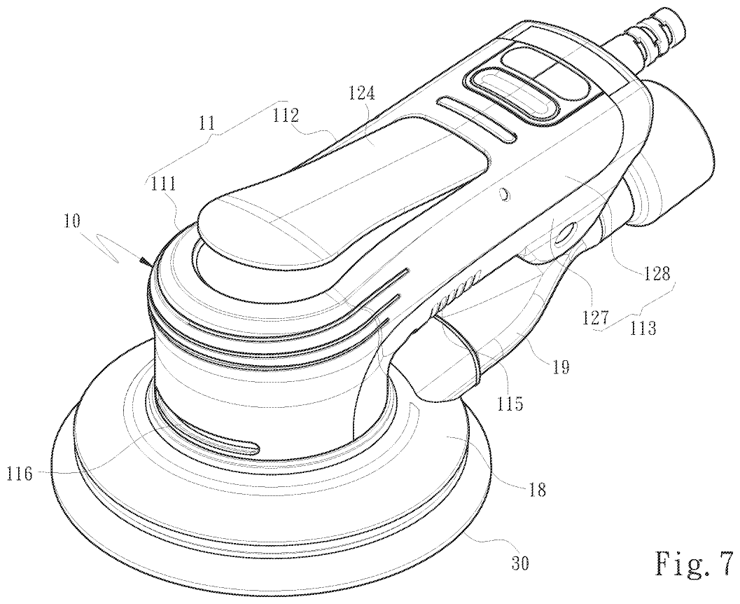

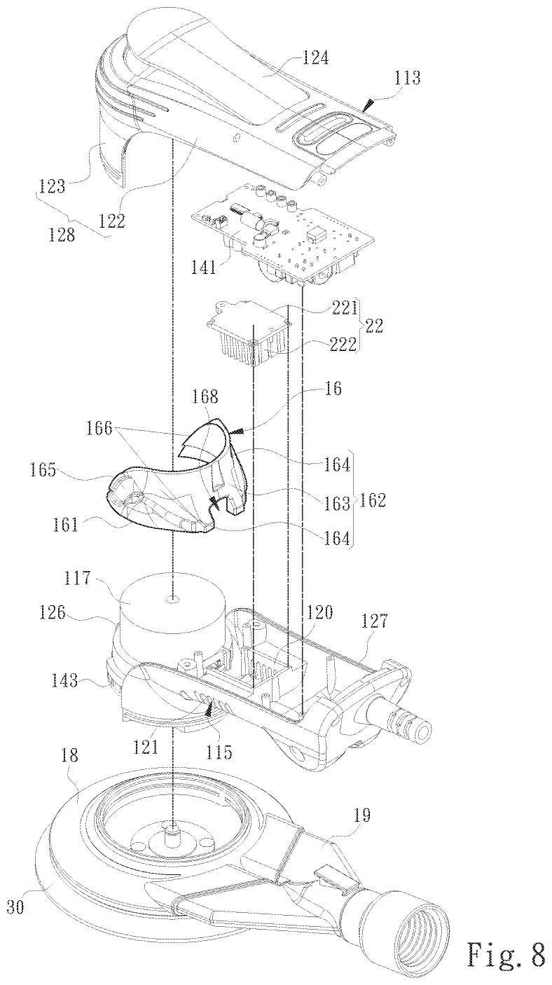

Please refer to FIG. 2, FIG. 3, FIG. 4, FIG. 5, FIG. 6, FIG. 7 and FIG. 8. In one embodiment, the grinding machine tool 10 comprises an air guider 16 disposed in the casing 11, the air guider 16 is located on the airflow passage 118 to receive the first heat dissipation airflow 60 from the body 112 and to form the second heat dissipation airflow 70. Specifically, the air guider 16 comprises a main body 161 disposed at the boundary between the head 111 and the body 112, and an ascending diversion portion 162 integrally formed with the main body 161. In one embodiment, the main body 161 is in an arc shape, and the arc shape can be a superior arc, an inferior arc, or a semi-circle according to implementation requirements. The ascending diversion portion 162 is located on a side of the main body 161 facing the body 112. The ascending diversion portion 162 further comprises a main guide surface 163 and two auxiliary guide surfaces 164 respectively disposed on two sides of the main guide surface 163. The two auxiliary guide surfaces 164 can be located on two opposite sides of the motor 142 (or the motor cover 117) after the air guider 16 is disposed. The two auxiliary guide surfaces 164 are not necessarily formed by a bottom edge of the main body 16, but can also be formed by extending from sides of the main guide surface 163. In addition, in one embodiment, the two auxiliary guide surfaces 164 are different from the main guide surface 163 in form, each of the two auxiliary guide surfaces 164 is composed of a plurality of curved surfaces. Furthermore, the main guide surface 163 guides the first heat dissipation airflow 60 to flow toward a top of the motor 142, and the two auxiliary guide surfaces 164 receive a portion of the first heat dissipation airflow 60 to generate the second heat dissipation airflow 70. The ascending diversion portion 162 makes the first heat dissipation airflow 60 entering from the air inlet 115 flow toward the top of the motor 142 in order to dissipate heat from the top of the motor 142, so that a degree of hotness of a part of the casing 11 where the user holds on with the palm can be reduced due to heat being dissipated from the top of the motor 142, thereby greatly improving the user's experience.

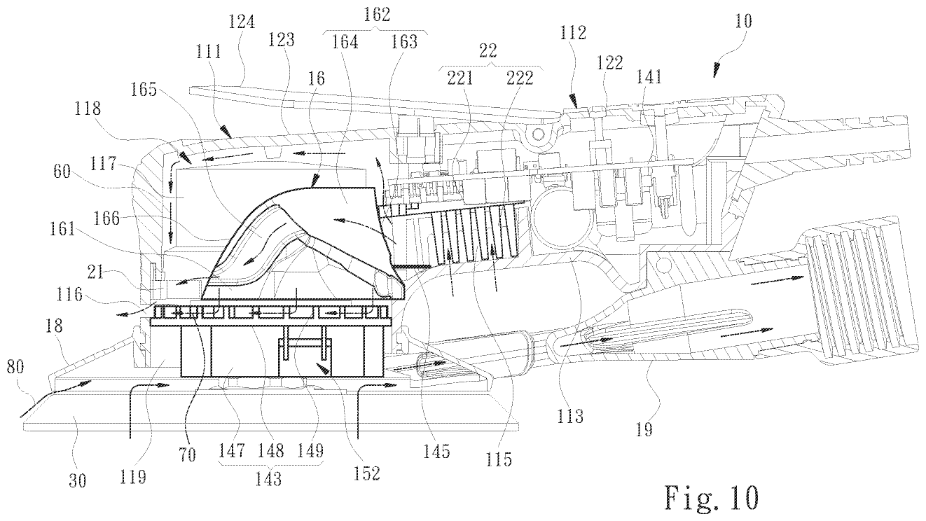

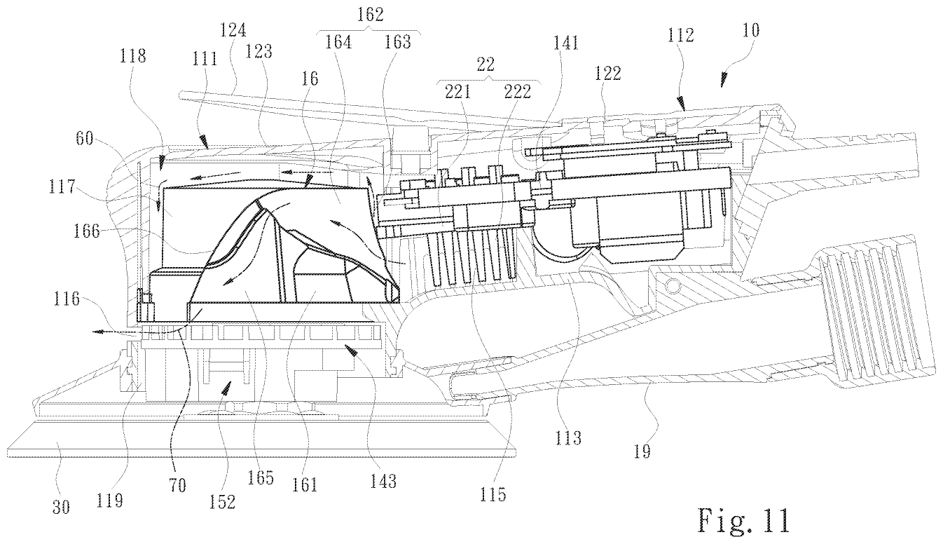

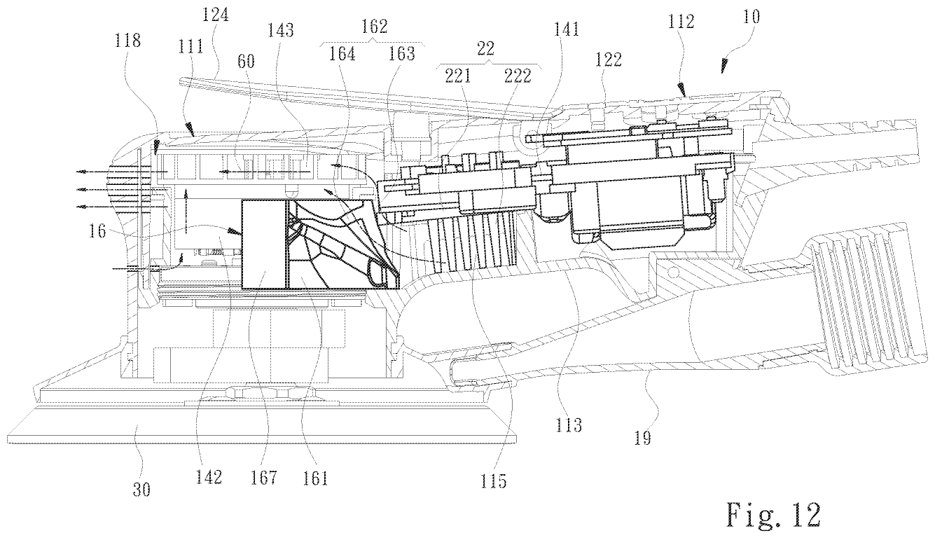

Please refer to FIG. 2, FIG. 3, FIG. 4, FIG. 5, FIG. 6, FIG. 7 and FIG. 8. In one embodiment, the air guider 16 comprises two descending diversion portions 165 respectively connected to two sides of the ascending diversion portion 162, and the two descending diversion portions 165 are integrally formed with the main body 161. The two descending diversion portions 165 receive the second heat dissipation airflow 70, so that the second heat dissipation airflow 70 is guided to descend when flowing therethrough. In one embodiment, at least one of the two descending diversion portions 165 tapers from a part thereof connected to the ascending diversion portion 162 toward a direction opposite from the ascending diversion portion 162. In addition, please refer to FIG. 11 as well. In one embodiment, at least one of the two descending diversion portions 165 gradually expands from a part thereof connected to the ascending diversion portion 162 toward a direction opposite from the ascending diversion portion 162. Please refer to FIG. 10. In one embodiment, the ascending diversion portion 162 extends from the bottom edge of the main body 161 to reach a top edge of the main body 161, and a width of the ascending diversion portion 162 at the bottom edge of the main body 161 is smaller than a width of the ascending diversion portion 162 at the top edge of the main body 161. A portion of the first heat dissipation airflow 60 guided by the main guide surface 163 flows toward a part of the airflow passage 118 located between a top of the motor cover 117 and the at least two casing parts 113, so that the portion of the first heat dissipation airflow 60 exchanges heat with a part of the head 111 where the user's palm contacts with. The two auxiliary guide surfaces 164 respectively guide a portion of the first heat dissipation airflow 60 to flow into a part of the airflow passage 118 located between the side of the motor cover 117 and the at least two casing parts 113, so that the portion of the first heat dissipation airflow 60 exchanges heat with the part of the head 111 for the user's fingers to grasp. In one embodiment, two sides of the main body 161 are respectively an inclined surface 166, and the two inclined surfaces 166 also serve as a guide for the first heat dissipation airflow 60 locally. Please refer to FIG. 12, in addition to the above, in one embodiment, the air guider 16 comprises two flow blockers 167 respectively disposed on the two sides of the ascending diversion portion 162, and the two flow blockers 167 are integrally formed with the main body 161. The two blocking blocks 167 form an obstacle between the motor cover 117 and the casing 11, so that the second heat dissipation airflow 70 and the first heat dissipation airflow 60 are confluent and flow toward the top of the motor 142. In addition, in one embodiment, the air guider 16 is formed with a wire opening 168 disposed on the main body 161, and the wire opening 168 is provided for a power line 145 connecting with the motor 142 and the circuit board 141 to pass through.

On the other hand, please refer to FIG. 2, FIG. 3, FIG. 4, FIG. 5 and FIG. 6. In one embodiment, the motor 142 further includes a main body 140 assembled with the output shaft 144, and a base 146 assembled with the grinding member 30 and driven by the output shaft 144. The main body 140 is a stator-rotor called by those having ordinary skill in the art, the main body 140 is electrically connected to the circuit board 141 to drive the output shaft 144 rotating, the base 146 is connected to a side of the output shaft 144 without facing the main body 140 and assembled with the airflow generating member 143, and the base 146 is driven by the output shaft 144 to rotate the airflow generating member 143 and the grinding member 30 when the motor 142 is activated. In one embodiment, after completion of assembling the airflow generating member 143 with the base 146, the airflow generating member 143 laterally faces the air outlet 116, and the airflow generating member 143 guides the first heat dissipation airflow 60 and the second heat dissipation airflow 70 to flow toward the air outlet 116 after rotating. Specifically, the airflow generating member 143 includes a mounting seat 147 assembled with the base 146, an end plate 148 extending from the mounting seat 147, and a plurality of fan blades 149 provided on the end plate 148. The end plate 148 is disposed on a side of the mounting seat 147 facing the motor 142, and the plurality of fan blades 149 are disposed on a side of the end plate 148 facing the motor 142. In one embodiment, where the plurality of fan blades 149 facing the side of the end plate 148 are assembled with the end plate 148, and where the plurality of fan blades 149 without facing the end plate 148 extend in a direction opposite to the end plate 148, so that the plurality of fan blades 149 are disposed on the end plate 148 in a standing manner. The plurality of fan blades 149 laterally face the air outlet 116 during the rotation process of the airflow generating member 143, and the plurality of fan blades 149 drive the first heat dissipation airflow 60 and the second heat dissipation airflow 70 after the airflow generating member 143 rotating, so that the first heat dissipation airflow 60 and the second heat dissipation airflow 70 flow toward an outer periphery of the end plate 148 and are discharged from the air outlet 116. In another embodiment, the mounting seat 147 includes an accommodating space 150 for disposal of the base 146, the base 146 includes two blocks 151 provided in staggered positions, and a shape of the accommodating space 150 matches the two blocks 151. In one embodiment, in order to assemble the base 146 with the airflow generating member 143 stably, the mounting seat 147 is provided with at least two restraining arms 152 to restrict one of the two blocks 151. In addition, the accommodating space 150 penetrates through two ends of the mounting seat 147, that is, the two ends of the mounting seat 147 are open to prevent the base 146 from detaching from the airflow generating member 143, the mounting seat 147 is provided with a limiting wall 153 at a side of the accommodating space 150 opposite to the end plate 148, and the limiting wall 153 and the at least two restraining arms 152 jointly restrain one of the two blocks 151.

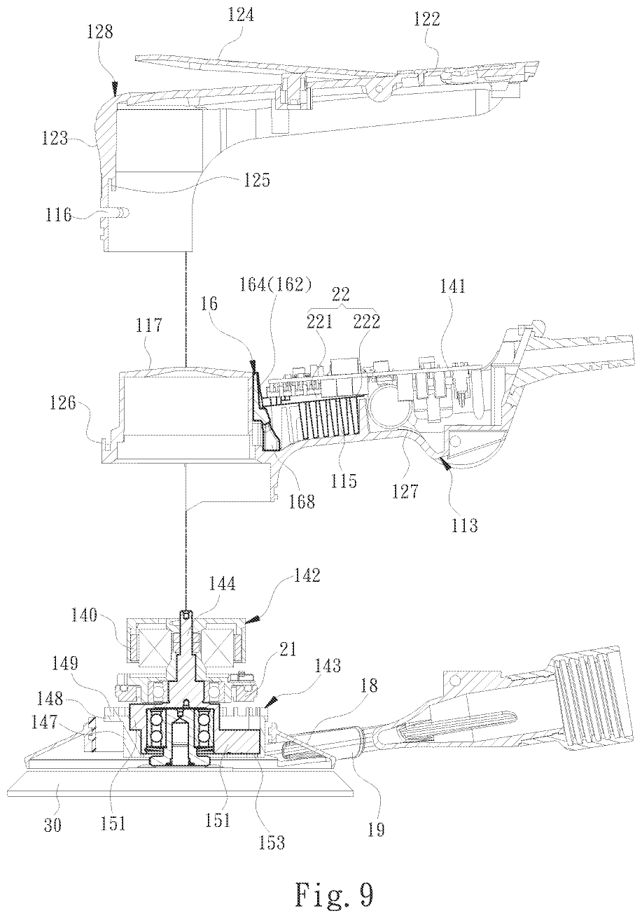

In the foregoing embodiment, the grinding machine tool 10 does not have a dust collecting structure. In order to reduce an amount of dust scattering around during grinding, the grinding machine tool 10 can be additionally equipped with a dust collecting device during grinding. Please refer to FIG. 8, FIG. 9 and FIG. 10, in another embodiment, the grinding machine tool 10 includes a dust collection function. Specifically, the grinding machine tool 10 does not blow the dust by using the first heat dissipation airflow 60 and the second heat dissipation airflow 70 during grinding, but uses an additional airflow path to suck the dust. Further, the casing 11 of the invention includes an assembly opening 119 provided on the head 111, the assembly opening 119 is provided for the airflow generating member 143 to be disposed therein, and a size of the assembly opening 119 is consistent with a size of the end plate 148. In other words, the head 111 of the grinding machine tool 10 of the invention is divided into an upper part and a lower part by the end plate 148, and a side of the end plate 148 opposite to the grinding member 30 in the head 111 is used to accommodate the motor 142, so that the first heat dissipation airflow 60 and the second heat dissipation airflow 70 are capable of flowing therein. A side of the end plate 148 facing the grinding member 30 is provided for a dust suction airflow 80 to flow therein, instead of the first heat dissipation airflow 60 and the second heat dissipation airflow 70. To further explain, the grinding machine tool 10 includes a dust cover 18 located on the head 111 and a dust collecting tube 19 provided on the dust cover 18, and the dust cover 18 is located on a side of the casing 11 facing the grinding member 30 to be assembled with the assembly opening 119. The dust cover 18 faces the grinding member 30 after being assembled, and the dust collecting tube 19 communicates with the assembly opening 119 through the dust cover 18 to form an airflow path. The grinding member 30 generates the dust during grinding, the dust is blocked by the end plate 148 and moves in the assembly opening 119, and the dust cover 18 prevents the dust from rapidly spreading to the outside. The high-pressure dust suction airflow 80 is generated after the dust collecting tube 19 is activated, the dust suction airflow 80 flows in the airflow path and drives the dust, so that the dust flows into the dust collecting tube 19 along the airflow path and a chance of flowing toward the airflow passage 118 is reduced.

On the other hand, please refer to FIG. 6, FIG. 7, FIG. 8, FIG. 9 and FIG. 10. In one embodiment, the grinding machine tool 10 includes an end cover 21 provided at the open side of the motor cover 117, and the end cover 21 is assembled to the side of the motor cover 117 facing the airflow generating member 143. The end cover 21 and the motor cover 117 jointly shield the motor 142 and enable the motor 142 work stably after completion of assembling the end cover 21.

On the other hand, please refer to FIG. 6, FIG. 7, FIG. 8, FIG. 9 and FIG. 10. In one embodiment, the circuit board 141 is disposed on the body 112, and the grinding machine tool 10 includes a heat sink 22 disposed on the body 112. The heat sink 22 is used to dissipate heat from the circuit board 141. The at least two casing parts 113 are formed with a positioning groove 120 for disposing of the heat sink 22, the air inlet 115 is located in the positioning groove 120, and the heat sink 22 is disposed of facing the air inlet 115. Further, the air inlet 115 is composed of a plurality of strip holes 121, the heat sink 22 includes a baseplate 221 provided on the circuit board 141 and a plurality of heat dissipation fins 222 provided on the baseplate 221, and the plurality of heat dissipation fins 222 do not interfere with the air inlet 115. Specifically, the plurality of heat dissipation fins 222 are provided at intervals, and the plurality of heat dissipation fins 222 are not disposed in an air inlet path of the strip holes 121. Thereby, the plurality of heat dissipation fins 222 do not affect air intake of the plurality of strip holes 121.

Furthermore, in one embodiment, the at least two casing parts 113 are divided into a lower casing 127 and an upper casing 128. The lower casing 127 is assembled with the motor cover 117, the upper casing 128 and the lower casing 127 jointly define the airflow passage 118 without contacting to the motor cover 117. In one embodiment, the lower casing 127 is formed with the air inlet 115 for the first heat dissipation airflow 60 entering into the casing 11 so that the first heat dissipation airflow 60 is able to flow between the upper casing 128 and the lower casing 127. In another embodiment, the motor cover 117 can be formed with one of the at least two casing parts 113 which is divided into the lower casing 127. Further, the upper casing 128 includes an assembling portion 122 which is assembled with the lower casing 127 to form the body 112, and an extending portion 123 extending from the assembling portion 122 to form the head 111 with the lower casing 127. The assembling portion 122 is assembled with an operable operating press plate 124 thereon, the extending portion 123 is covered above the motor cover 117, and the airflow passage 118 is formed between the motor cover 117 and the upper casing 128. In one embodiment, the extending portion 123 is formed with an assembling hole 125, the motor cover 117 is formed with an assembling structure 126 that matches the assembling hole 125, and the assembling structure 126 is assembled in the assembling hole 125 to assist the motor cover 117 to be stably disposed in the head 111.

What is claimed is:

1. An air guider disposed in a grinding machine tool, wherein the grinding machine tool comprises a casing and a motor disposed in the casing, the casing comprises a head for disposing the motor and a body formed with at least one air inlet, the air guider comprising:
a main body, disposed at a junction between the head and the body; and
an ascending diversion portion, integrally formed with the main body and located on a side of the main body facing the body, and the ascending diversion portion comprising a main guide surface which guides a first heat dissipation airflow entering from the air inlet to flow toward a top of the motor, and two auxiliary guide surfaces which are respectively disposed on two sides of the main guide surface to generate a second heat dissipation airflow.

2. The air guider as claimed in claim 1, wherein the air guider comprises two descending diversion portions respectively connected to two sides of the ascending diversion portion, and the two descending diversion portions are integrally formed with the main body.

3. The air guider as claimed in claim 2, wherein at least one of the two descending diversion portions tapers from a part thereof connected to the ascending diversion portion toward a direction opposite from the ascending diversion portion.

4. The air guider as claimed in claim 3, wherein the ascending diversion portion extends from a bottom edge of the main body to reach a top edge of the main body, and a width of the ascending diversion portion at the bottom edge of the main body is smaller than a width of the ascending diversion portion at the top edge of the main body.

5. The air guider as claimed in claim 3, wherein the two auxiliary guide surfaces are composed of a plurality of curved surfaces.

6. The air guider as claimed in claim 3, wherein the main body is in an arc shape.

7. The air guider as claimed in claim 6, wherein two sides of the main body are respectively an inclined surface.

8. The air guider as claimed in claim 2, wherein at least one of the two descending diversion portions gradually expands from a part thereof connected to the ascending diversion portion toward a direction opposite from the ascending diversion portion.

9. The air guider as claimed in claim 8, wherein the ascending diversion portion extends from a bottom edge of the main body to reach a top edge of the main body, and a width of the ascending diversion portion at the bottom edge of the main body is smaller than a width of the ascending diversion portion at the top edge of the main body.

10. The air guider as claimed in claim 9, wherein the two auxiliary guide surfaces are composed of a plurality of curved surfaces.

11. The air guider as claimed in claim 10, wherein the main body is in an arc shape.

12. The air guider as claimed in claim 11, wherein two sides of the main body are respectively an inclined surface.

13. The air guider as claimed in claim 1, wherein the main body comprises two flow blockers respectively disposed on two sides of the ascending diversion portion, and the two flow blockers are integrally formed with the main body.

14. The air guider as claimed in claim 13, wherein the main body is in an arc shape, and the two flow blockers are respectively located on two sides of the main body.

15. The air guider as claimed in claim 13, wherein the ascending diversion portion extends from a bottom edge of the main body to reach a top edge of the main body, and a width of the ascending diversion portion at the bottom edge of the main body is smaller than a width of the ascending diversion portion at the top edge of the main body.

16. The air guider as claimed in claim 15, wherein the two auxiliary guide surfaces are composed of a plurality of curved surfaces.

17. The air guider as claimed in claim 1, wherein the air guider comprises a wire opening disposed on the main body.
